(19) United States
(12) Patent Application Publication
(10) Pub. No.: US 2010/0247891 A1
(43) Pub. Date: Sep. 30, 2010

(54) Transparent Film and Intermediate Transfer Belt Having Multilayered Structure Using the Same

(75) Inventors: Young Kyu CHANG, Gunpo-si (KR); Young Sil LEE, Gunpo-si (KR); Sei Jin OH, Gunpo-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/813,574

(22) Filed: Jun. 11, 2010

Related U.S. Application Data
(63) Continuation-in-part of application No. PCT/KR2008/007360, filed on Dec. 12, 2008.

(30) Foreign Application Priority Data
Dec. 13, 2007 (KR) 10-2007-0129691

(51) Int. Cl. B32B 5/16; B29C 47/00

(52) U.S. Cl. 428/220; 428/323; 264/176.1

(57) ABSTRACT

Disclosed herein is a transfer belt for an image forming apparatus comprising (A) a base layer comprising a thermoplastic resin; and (B) a surface layer comprising a thermoplastic resin composite in which carbon nanotubes are dispersed, wherein the surface layer is laminated on one side of the base layer. The transfer belt for an image forming apparatus can have high surface electrical resistance, resistance homogeneity, homogeneous electrical conductivity, and good mechanical properties.

### CROSS-REFERENCE TO RELATED APPLICATIONS

This application is a continuation-in-part of International Application No. PCT/KR2008/007360, filed Dec. 12, 2008, pending, which designates the U.S., published as WO 2009/075543, and is incorporated herein by reference in its entirety, and claims priority therefrom under 35 USC Section 120. This application also claims priority under 35 USC Section 119 from Korean Patent Application No. 10-2007-0129691, filed Dec. 13, 2007, in the Korean Intellectual Property Office, the entire disclosure of which is also incorporated herein by reference.

### FIELD OF THE INVENTION

The present invention relates to a transfer belt which can be used in an image forming apparatus.

### BACKGROUND OF THE INVENTION

Recent developments in information devices such as personal computers, digital video players, digital cameras, cellular phones equipped with cameras, and the like have improved technology and capacity of the same to more easily treat color information of pictures or images in the devices. Furthermore, there is an increasing demand for improved technology in color printers, such as high speeds, high image quality, compact size, and high reliability, among other properties. One important element for improving color printer technology is an intermediate transfer belt.

There is also a demand for electrophotographic apparatus such as copiers, printers, and the like with high speed, high image quality, and a compact size, and which can be used with conventional paper. In order to satisfy such demands, the transfer process of an electrophotographic apparatus can employ a semiconductive intermediate transfer belt which is becoming an important part of such devices.

Materials used for the intermediate transfer belt include polycarbonate (PC) resins, polyvinylidene fluoride (PVDF) resins, polyamideimide (PAI) resins, polyimide (PI) resins, and rubber. It is desirable that the transfer belt for an image forming apparatus has large resistivity (surface resistivity) in the circumferential direction of the belt and resistivity in the thickness direction (volume resistivity) smaller than the surface resistivity. It is further desirable that both resistivities do not change by position on the belt, the environment in which it is used, or voltage, and that the transfer belt has a high tensile elastic modulus in the circumferential direction, high smoothness, and a large contact angle whereby the toner can be easily transferred to the transfer material (paper) from the belt (excellent toner releasing property). It is also desirable that the transfer belt does not chemically stain the photosensitive drum or the toner (excellent contamination resistance), and that it also has flame retardancy.

The semiconductive thermoplastic resin composition used in the preparation of an intermediate transfer belt is conventionally prepared by adding and dispersing a conductive additive such as carbon black into thermoplastic resins. A large amount of the conductive additive such as carbon black needs to be used (more than 10% based on the total weight) in order to obtain sufficient electroconductivity. However, if the conductive additive is used in a large amount, mechanical properties of the electroconductive thermoplastic resin such as impact strength and elastic modulus may be significantly deteriorated.

Japanese Patent No. 2,560,727 discloses a method of preparing a transfer belt by dispersing carbon black in polyimide. However, the method has a drawback in that more than 10% by weight of the carbon black has to be prepared in solution to be dispersed in the resin.

U.S. Pat. No. 5,021,036 discloses a transfer belt obtained by dispersing 5 to 20% by weight of acetylene black in polycarbonate. However, it is difficult to disperse a large amount of filler and the belt can have deteriorated physical properties.

U.S. Pat. No. 4,559,164 discloses a method for preparing a conductive resin by blending aromatic polycarbonate, polyalkylene terephthalate, and carbon black at a predetermined amount. However, the patent does not disclose a sheet or a film.

U.S. Pat. No. 4,876,033 discloses a method for preparing a sheet by blending polycarbonate, polyalkylene terephthalate, carbon black, and graphite. However, since the resins disclosed in U.S. Pat. Nos. 4,559,164 and 4,876,033 have less than 20% elongation at break, they are not suitable for molding films.

U.S. Patent Publication No. 2007/0116958 discloses a transfer belt composed of a film having a multilayered structure. The multilayered structure can be made by coextrusion, but the structure is not easily folded due to the large difference between the physical properties of a film layer containing a large amount of carbon black and a base layer.

Thus, generally, films for transfer belts are prepared by dispersing 10 to 20% by weight of carbon black in a resin such as polycarbonate, polyimide, polyamideimide, or polyvinylidene fluoride. However, when such a large amount of carbon black is used, it is difficult to obtain a homogeneous dispersion and it can cause deterioration of physical properties of the film.

### SUMMARY OF THE INVENTION

The present inventors have developed a transfer belt having a multilayered structure, which can be useful in an image forming apparatus. For example, the transfer belt can be used to transfer a toner image from a photosensitive drum onto a transfer material (paper) in an image forming apparatus using an electrophotographic system. Exemplary color image forming apparatus which can include the transfer belt of the invention include without limitation color copiers, color laser printers and the like.

The transfer belt can include a surface layer and a base layer. The base layer may be produced using various types of polymeric resins, which can provide flexibility to the base layer and allow easy treatment of the same to prevent creasing.

The surface layer of the transfer belt may include conductive filler. Because the transfer belt can include conductive filler only in the surface layer thereof, this can reduce the amount of conductive filler required. Yet, despite the small amount of conductive filler used, the transfer belt can have good conductivity. In addition, because only a small amount of conductive filler may be used, the transfer belt can maintain good mechanical properties and production costs may be reduced.

The transfer belt can also have excellent homogeneous resistance, toner releasing property, contamination resistance, and non-staining properties, while maintaining the viscosity and elasticity of conventional polymeric resins.

The transfer belt of the invention may also have high surface resistivity and good dispersibility. Further, the conductivity of the belt may also be controlled by controlling the thickness of the surface layer. Accordingly, the transfer belt may be used in a variety of applications.

The transfer belt for an image forming apparatus of the present invention comprises (A) a base layer comprising a thermoplastic resin; and (B) a surface layer comprising a thermoplastic resin composite in which carbon nanotubes are dispersed. The transfer belt may have a cylindrical form.

In exemplary embodiments, the surface layer (B) comprises about 95 to about 99.9% by weight of a thermoplastic resin and about 0.1 to about 5% by weight of carbon nanotubes.

The carbon nanotubes may have a diameter of about 0.5 to about 100 nm, a length of about 0.01 to about 100 μm, and an aspect ratio of about 100 to about 1,000.

Examples of the thermoplastic resin may include without limitation polyolefin resins, polyacetal resins, acrylic resins, polymethacrylic resins, polycarbonate resins, styrenic resins, polyester resins, polyphenylene ether resins, polyarylate resins, polyamide resins, polyarylsulfone resins, polyetherimide resins, polyethersulfone resins, vinylidene fluoride resins, polysulfone resins, liquid crystal polymer resins, copolymers thereof and combinations thereof.

In exemplary embodiments, the thermoplastic resin of the present invention may further comprise one or more additives such as reaction stabilizers, transesterification inhibitors, UV absorbing agents, thermal stabilizers, antioxidants, flame retardants, lubricants, pigments, dyes, inorganic fillers, plasticizers, impact modifiers, and the like.

In exemplary embodiments, the transfer belt may have a surface electrical resistance of about 1×10⁸ to about 1×10¹² Ω/sq, when a voltage of about 100 to about 250 V is applied.

The transfer belt may have a thickness of about 50 to about 150 μm. The surface layer (B) may have a thickness of about 0.2 to about 30 μm.

In an exemplary embodiment, the surface layer (B) may have a thickness of about 0.15 to about 3 μm and the amount of the carbon nanotubes therein may range from about 2.5 to about 5% by weight.

In another exemplary embodiment, the surface layer (B) may have a thickness of about 2 to about 25 μm and the amount of the carbon nanotubes therein may range from about 1 to about 2.4% by weight.

The present invention also provides a method for preparing a transfer belt for an image forming apparatus. The method comprises coextruding a thermoplastic resin to form a base layer and a thermoplastic resin composite to form a surface layer in an extruder equipped with a ring die. The thermoplastic resin composite has carbon nanotubes dispersed therein.

In exemplary embodiments, the thermoplastic resin composite comprises about 95 to about 99.9% by weight of a thermoplastic resin and about 0.1 to about 5% by weight of carbon nanotubes.

The present invention also provides a transparent conductive film used for the transfer belt for an image forming apparatus. The transparent film comprises (A) a base layer comprising a thermoplastic resin; and (B) a surface layer comprising a thermoplastic resin composite in which carbon nanotubes are dispersed. In exemplary embodiments, the transparent film may have conductivity.

In exemplary embodiments, the surface layer (B) may comprise about 95 to about 99.9% by weight of a thermoplastic resin and about 0.1 to about 5% by weight of carbon nanotubes.

The carbon nanotubes may have a diameter of about 0.5 to about 100 nm, a length of about 0.01 to about 100 μm, and an aspect ratio of about 100 to about 1,000.

Furthermore, examples of the thermoplastic resin may include without limitation polyolefin resins, polyacetal resins, acrylic resins, polymethacrylic resins, polycarbonate resins, styrenic resins, polyester resins, polyphenylene ether resins, polyarylate resins, polyamide resins, polyarylsulfone resins, polyetherimide resins, polyethersulfone resins, vinylidene fluoride resins, polysulfone resins, liquid crystal polymer resins, copolymers thereof, and combinations thereof.

The thermoplastic resin of the present invention may further comprise one or more additives selected from reaction stabilizers, transesterification inhibitors, UV absorbing agents, thermal stabilizers, antioxidants, flame retardants, lubricants, pigments, dyes, inorganic fillers, plasticizers, impact modifiers, and the like.

The components of the resin composition of the transfer belt for an image forming apparatus will be described more fully hereinafter in the following detailed description of the invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

(A) Base layer

Any thermoplastic resin suitable for extrusion or injection molding, without limitation, including conventional thermoplastic plastics and thermoplastic engineering plastics, can be used in the base layer of the present invention.

Examples of the thermoplastic resin used in the base layer (A) may include without limitation polyolefin resins, polyacetal resins, acrylic resins, polymethacrylic resins, polycarbonate resins, styrenic resins, polyester resins, polyphenylene ether resins, polyarylate resins, polyamide resins, polyarylsulfone resins, polyetherimide resins, polyethersulfone resins, vinylidene fluoride resins, polysulfone resins, liquid crystal polymer resins and the like. These resins can be used alone, as a copolymer thereof or in combination with one another.

In exemplary embodiments, polyolefin resins such as polyethylene resins, polypropylene resins, ethylene-vinyl acetate copolymer resins and ethylene-methylmethacrylate copolymer resins; styrenic resins; or thermoplastic engineering plastics such as polyamide resins, polyester resins such as polyethylene terephthalate and polybutylene terephthalate, and polycarbonate resins can be used in the base layer, taking into consideration the applications or physical properties of the thermoplastic resin of the base layer. However, the thermoplastic resin is not limited to the aforementioned resins. Thus other thermoplastic resins can also be used.

In an exemplary embodiment of the present invention, a polycarbonate resin is used as the thermoplastic resin of the base layer (A). The polycarbonate resin can have a weight average molecular weight (Mw) of about 15,000 to about 50,000, for example about 20,000 to about 40,000.

Examples of the polycarbonate resin may include, but are not limited to, linear polycarbonate, branched polycarbonate, polyester carbonate copolymers, and the like, and combinations thereof. Further, polycarbonate homopolymers, polycarbonate copolymers, or a combination thereof may be used without limitation.

Branched polycarbonates can be prepared using known techniques, such as by incorporating about 0.05 to about 2 mol %, based on the total quantity of diphenols used, of tri- or higher functional compounds, for example, those with three or more phenolic groups. Polyester carbonate copolymers may also be prepared by known techniques, such as by reacting difunctional carboxylic acid with dihydric phenol and carbonate precursor, and may be used alone or in combination with other polycarbonate resins. In another exemplary embodiment of the present invention, a polybutylene terephthalate resin is used as the thermoplastic resin of the base layer (A). The polybutylene terephthalate resin can be prepared by a direct esterification or a transesterification of 1,4-butanediol and terephthalic acid or dimethyl terephthalate followed by polycondensation and is commercially available. In another exemplary embodiment, in order to increase impact strength of the resin, polybutylene terephthalate may be copolymerized with polytetramethylene glycol (PTMG), polyethylene glycol (PEG), polypropylene glycol (PPG), low molecular weight aliphatic polyester or aliphatic polyamide, or the polybutylene terephthalate can be used in the form of modified polybutylene terephthalate by blending components for improving impact strength therewith.

The polybutylene terephthalate used in the present invention may have an intrinsic viscosity [η] in the range of about 0.36 to about 1.60 as measured in a solvent of o-chlorophenol at a temperature of about 25° C., for example about 0.52 to about 1.25. Within these ranges of the intrinsic viscosity, a good balance of mechanical properties and moldability may be obtained.

In other exemplary embodiments, polycarbonate or a thermoplastic elastomer having a melting point of about 200° C. or more or a copolymer thereof may be used. Exemplary thermoplastic elastomers may include without limitation polyester, polyamide, polyether, polyolefin, polyurethane, styrenic resin, acrylic resin and the like, and combinations thereof.

The thermoplastic resin of the present invention may further comprise one or more additives such as reaction stabilizers, transesterification inhibitors, UV absorbing agents, thermal stabilizers, antioxidants, flame retardants, lubricants, pigments, dyes, inorganic fillers, plasticizers, impact modifiers, and the like, and combinations thereof. The additive may be used in an amount of about 10 parts by weight or less, for example about 0.001 to about 10 parts by weight, based on 100 parts by weight of the thermoplastic resin.

(B) Surface layer

The surface layer (B) is laminated onto one side of the base layer (A). The surface layer (B) comprises a thermoplastic resin composite in which carbon nanotubes are dispersed. The surface layer (B) comprises about 95 to about 99.9% by weight of a thermoplastic resin and about 0.1 to about 5% by weight of carbon nanotubes. In some embodiments, the surface layer (B) includes the thermoplastic resin in an amount of about 95, 96, 97, 98, 99, 99.1, 99.2, 99.3, 99.4, 99.5, 99.6, 99.7, 99.8, or 99.9% by weight. Further, according to some embodiments of the present invention, the amount of the thermoplastic resin can be in a range from about any of the foregoing amounts to about any other of the foregoing amounts. In some embodiments, the surface layer (B) includes the carbon nanotubes in an amount of about 0.1, 0.2, 0.3, 0.4, 0.5, 0.6, 0.7, 0.8, 0.9, 1, 2, 3, 4, or 5% by weight. Further, according to some embodiments of the present invention, the amount of the carbon nanotubes can be in a range from about any of the foregoing amounts to about any other of the foregoing amounts.

Any thermoplastic resin suitable for extrusion or injection molding, without limitation, including conventional thermoplastic plastics and thermoplastic engineering plastics, can be used in the surface layer of the present invention. Examples of the thermoplastic resin used in the surface layer may include without limitation polyolefin resins, polyacetal resins, acrylic resins, polymethacrylic resins, polycarbonate resins, styrenic resins, polyester resins, polyphenylene ether resins, polyarylate resins, polyamide resins, polyarylsulfone resins, polyetherimide resins, polyethersulfone resins, vinylidene fluoride resins, polysulfone resins, liquid crystal polymer resins and the like. These resins can be used alone, as a copolymer thereof or in combination with one another. The thermoplastic resin(s) present in the surface layer (B) may be the same or different from the thermoplastic resin(s) in the base layer (A).

In exemplary embodiments, polyolefin resins such as polyethylene resins, polypropylene resins, ethylene-vinyl acetate copolymer resins and ethylene-methylmethacrylate copolymer resins; styrenic resins; or thermoplastic engineering plastics such as polyamide resins, polyester resins such as polyethylene terephthalate and polybutylene terephthalate, or polycarbonate resins can be used in the thermoplastic resin composite of the base layer, taking into consideration the applications or physical properties of the thermoplastic resin composite. However, the thermoplastic resin is not limited to the aforementioned resins. Thus other thermoplastic resins can also be used.

In an exemplary embodiment of the present invention, a polycarbonate resin is used as the thermoplastic resin. The polycarbonate resin can have a weight average molecular weight (Mw) of about 15,000 to about 50,000, for example about 20,000 to about 40,000.

Examples of the polycarbonate resin may include, but are not limited to, linear polycarbonate, branched polycarbonate, polyester carbonate copolymer, and the like, and combinations thereof. Further, polycarbonate homopolymers, polycarbonate copolymers, or a combination thereof may be used without limitation.

Branched polycarbonates can be prepared using known techniques, such as by incorporating about 0.05 to about 2 mol %, based on the total quantity of diphenols used, of tri- or higher functional compounds, for example, those with three or more phenolic groups. Polyester carbonate copolymers may also be prepared using known techniques, such as by reacting difunctional carboxylic acid with dihydric phenol and carbonate precursor and may be used alone or in combination with other polycarbonate resins.

In an exemplary embodiment of the present invention, the thermoplastic resin includes a polybutylene terephthalate resin. The polybutylene terephthalate resin can be prepared by a direct esterification or a transesterification of 1,4-butanediol and terephthalic acid or dimethyl terephthalate followed by polycondensation and is commercially available. In another exemplary embodiment, in order to increase impact strength of the resin, polybutylene terephthalate may be copolymerized with polytetramethylene glycol (PTMG), polyethylene glycol (PEG), polypropylene glycol (PPG), low molecular weight aliphatic polyester or aliphatic polyamide, or the polybutylene terephthalate can be used in form of modified polybutylene terephthalate.

The polybutylene terephthalate used in the present invention may have an intrinsic viscosity [η] in the range of about 0.36 to about 1.60 as measured in a solvent of o-chlorophenol at a temperature of about 25° C., for example about 0.52 to about 1.25. Within these ranges of the intrinsic viscosity, a good balance of mechanical properties and moldability may be obtained.

In the present invention, carbon nanotubes which have high mechanical properties such as mechanical strength, Young's Modulus, and aspect ratio may be used as a conductive dispersant in the surface layer (B). Since a carbon nanotube has high electroconductivity and thermal stability, when the carbon nanotube is used in a polymer composite, a carbon nanotube-polymer composite having improved mechanical, thermal, and electrical properties can be obtained.

Examples of methods for preparing the carbon nanotube include arc-discharge, laser ablation, plasma chemical vapor deposition, thermal chemical vapor deposition, electrolysis, and the like. Any carbon nanotube can be used in the present invention, regardless of the preparation methods thereof.

The carbon nanotube can be classified into single-walled carbon nanotubes, double-walled carbon nanotubes, and multi-walled carbon nanotubes, depending the number of walls. In the present invention, any carbon nanotube can be used regardless of the number of walls. In an exemplary embodiment, multi-walled carbon nanotubes can be used taking into consideration cost and moldability.

The carbon nanotubes used in the present invention may have a diameter of about 0.5 to 100 nm, for example about 1 to about 10 nm. The carbon nanotubes may have a length of about 0.01 to about 100 μm, for example about 0.5 to about 10 μm. Within these ranges, desirable electroconductivity can be obtained.

The carbon nanotubes used in the present invention may have a high aspect ratio (L/D) due to the aforementioned size, and the aspect ratio may be more than about 100, for example about 100 to about 1,000. Within these ranges, desirable electroconductivity can be obtained.

The amount of carbon nanotubes contained in the thermoplastic resin composite may range from about 0.1 to about 5% by weight, for example about 0.3 to about 3% by weight, and as another example about 0.5 to about 2.5% by weight. If the amount of carbon nanotubes is less than about 0.1% by weight, sufficient electroconductivity may not be obtained. If the amount of carbon nanotubes is more than about 5% by weight, dispersibility and intrinsic properties of the resin may be deteriorated.

The thermoplastic resin composite in which carbon nanotubes are dispersed may further comprise one or more additives such as reaction stabilizers, transesterification inhibitors, UV absorbing agents, thermal stabilizers, antioxidants, flame retardants, lubricants, pigments, dyes, inorganic fillers, plasticizers, impact modifiers, and the like, and combinations thereof. The additives may be used in an amount of about 10 parts by weight or less, for example about 0.001 to about 10 parts by weight, based on 100 parts by weight of the thermoplastic resin composite.

### Preparation of Semiconductive Transfer Belt Having Multi-Layered Structure

The transfer belt may be prepared by coextrusion of thermoplastic resin of the base layer and the thermoplastic resin composite in which carbon nanotubes are dispersed.

In exemplary embodiments, the thermoplastic resin of the base layer may be prepared by mixing the components of the present invention and extruding the mixture to prepare a product in pellet form. The thermoplastic resin of the base layer may be melt-extruded through a single screw extruder (L/D=36, Φ=65 mm).

The thermoplastic resin composite of the surface layer in which carbon nanotubes are dispersed may be prepared by mixing the components thereof, i.e., thermoplastic resin, carbon nanotubes and optionally one or more additives, and extruding the mixture to prepare a product in pellet form. The thermoplastic resin composite of the surface layer may be melt-extruded through a single screw extruder (L/D=36, Φ=40 mm). In exemplary embodiments, the thermoplastic resin composite pellets comprise about 95 to about 99.9% by weight of a thermoplastic resin and about 0.1 to about 5% by weight of carbon nanotubes.

Both resins may be laminated through a feed block and may be introduced to a single screw extruder equipped with a ring die. The resin composition melted at the opening of the ring die is solidified through a cooling system. Then a transfer belt in a cylindrical form can be obtained by extruding from the ring die. As such, the resin discharged from a mold may be rapidly cooled using water, air or a cooling system for amorphization. More particularly, the resin discharged from the extruder forms a cylindrical form and when it goes through a metal mold and a cooling system, heat retained in the resin may be absorbed so as to decrease the degree of morphological alternation and crystallinity. In addition, the resin discharged from the metal mold may be drawn at a constant speed in order to form a thin cylindrical film. The drawing speed can range from about 1 to about 7 m/min.

The semiconductive transfer belt prepared by the aforementioned method may have a thickness of about 50 to about 150 μm, for example about 80 to about 120 μm.

In the present invention, the thickness of the surface layer (B) comprising the thermoplastic resin composite in which carbon nanotubes are dispersed can vary depending on the amount of carbon nanotubes. The thickness of the surface later (B) can be appropriately controlled according to the amount of carbon nanotubes, because even though the same amount of carbon nanotubes are used, if the thickness of the surface layer (B) becomes too large, then the transparency may be deteriorated. In an exemplary embodiment, the thickness of the surface layer (B) may range from about 0.2 to about 30 μm.

In an exemplary embodiment, when the amount of carbon nanotubes in the surface layer (B) is about 2.5 to about 5% by weight, the thickness of the surface layer (B) may range from about 0.15 to about 3 μm, for example, about 0.2 to about 2 μm. In another exemplary embodiment, when the amount of carbon nanotubes in the surface layer (B) is about 1 to about 2.4% by weight, the thickness of the surface layer (B) may range from about 2 to about 25 μm, for example, about 2 to about 10 μm. Within these ranges, the surface layer may have high electroconductivity and also the base layer may maintain good physical properties, which are desirable conditions for the transfer belt to be useful in an image forming apparatus.

The semiconductive transfer belt may have a surface electrical resistance of about 1×10⁸ to about 1×10¹² Ω/sq, when a voltage of about 100 to about 250 V is applied.

The surface electrical resistance of the transfer belt having a multilayered structure can be controlled through the amount of carbon nanotubes and the film processing speed.

In the preparation of a multilayered transfer belt, various types of polymer resins can be employed as a base layer. Therefore, it is possible to impart flexibility to the film which results in easy treatment of the film and reduction of inferior products. Furthermore, since a conductive filler can be introduced into a surface layer only, the amount of conductive filler used can be reduced and thereby the production cost for film can be reduced. Furthermore, it also has an advantage in that the transfer belt for an image forming apparatus with a multilayered structure is applicable for various uses by controlling conductivity of the film through the control of a thickness of the surface layer.

Another aspect of the present invention provides a transparent conductive film used in the transfer belt for an image forming apparatus. The transparent conductive film may be flexible. In exemplary embodiments, the transparent film comprises (A) a base layer comprising a thermoplastic resin; and (B) a surface layer comprising a thermoplastic resin composite in which carbon nanotubes are dispersed, and the film is a cylindrical form. In an exemplary embodiment, the transparent film may have conductivity.

In exemplary embodiments, the surface layer (B) may comprise about 95 to about 99.9% by weight of a thermoplastic resin and about 0.1 to about 5% by weight of carbon nanotubes.

The carbon nanotubes may have a diameter of about 0.5 to about 100 nm, a length of about 0.01 to about 100 μm, and an aspect ratio of about 100 to about 1,000.

In addition, the thermoplastic resin may include without limitation polyolefin resins, polyacetal resins, acrylic resins, polymethacrylic resins, polycarbonate resins, styrenic resins, polyester resins, polyphenylene ether resins, polyarylate resins, polyamide resins, polyarylsulfone resins, polyetherimide resins, polyethersulfone resins, vinylidene fluoride resins, polysulfone resins, liquid crystal polymer resins, and the like. These resins can be used alone, as a copolymer thereof or in combination with one another.

The thermoplastic resin of the present invention may further comprise one or more additives such as reaction stabilizers, transesterification inhibitors, UV absorbing agents, thermal stabilizers, antioxidants, flame retardants, lubricants, pigments, dyes, inorganic fillers, plasticizers, impact modifiers, and the like, and combinations thereof.

The invention may be better understood by reference to the following examples which are intended for the purpose of illustration and are not to be construed as in any way limiting the scope of the present invention, which is defined in the claims appended hereto.

### EXAMPLES

The specifications of components used in the Examples and Comparative Examples are as follows.

(A) Base layer: Polycarbonate resin manufactured by Teijin Chemicals Ltd. of Japan (product name: PANLITE L-1250 WP) is used.

(B) Surface layer

(B1) Thermoplastic resin

(B11) Polycarbonate: Bisphenol-A linear polycarbonate with a weight average molecular weight of 25,000 (Mw) manufactured by Teijin Chemicals Ltd. of Japan (product name: PANLITE L-1225 WX) is used.

(B12) Polybutylene terephthalate: polybutylene terephthalate (Chang Chun PBT1200-211H) having an intrinsic viscosity of 1.0 prepared by direct esterification of 1,4-butanediol and terephthalic acid followed by polycondensation is used.

(B2) Conductive dispersant

(B21) Carbon nanotube: The multi-walled carbon nanotubes manufactured by Nanocyl company of Belgium (product name: NC 7000) having a thickness of 10˜15 nm and a length of 1˜25 μm is used.

(B22) Carbon black: Ketjen black 600JD manufactured by Mitsubishi Chemical of Japan is used.

### Examples 1-11

The components as shown in the following table 1 are added to a conventional mixer and the mixture is extruded through a conventional twin screw extruder (L/D=36, φ=45 mm) to prepare pellets. The prepared pellets of the resin composition containing carbon nanotubes and the thermoplastic resin for a base film are introduced into different input openings of a single screw extruder equipped with a ring die. After each resin is melted, the melted resins are controlled to meet at the opening of the ring die, while controlling an amount of discharge. The resin compositions melted at the opening of ring die are solidified through a cooling system and then extruded from the ring die to obtain a transfer belt in a cylindrical form. The properties of the transfer belt such as surface electrical resistance, transparency, and thickness are measured and the results are shown in Table 1.

### Comparative Examples 1-2

The components as shown in the following table 1 in which carbon black is used instead of the carbon nanotubes are added to a conventional mixer and the mixture is extruded through a conventional twin screw extruder (L/D=36, Φ=45 mm) to prepare pellets. The prepared pellets of the resin composition containing carbon black and the thermoplastic resin for a base film are introduced into different input openings of a single screw extruder equipped with a ring die. After each resin is melted, the melted resins are controlled to meet at the opening of the ring die, while controlling an amount of discharge. The resin composites melted at the opening of ring die are solidified through a cooling system and then extruded from the ring die to obtain a transfer belt in a cylindrical form. The properties of the transfer belt such as surface electrical resistance, transparency, and thickness are measured and the results are shown in Table 1.

The physical properties of the test specimens are measured as follows and the results are shown in Table 1 below.

1) Surface electrical resistance (Ω/sq): The surface electrical resistance is measured by a conventional four-point method using Hiresta UP manufactured by Mitsubishi Chemical (product name: MCP-HT450).

2) Thickness (μm): The thickness is measured using contact type measuring apparatus manufactured by Mitutoyo (product name: micrometer).

3) Transparency: The absorption of the film at 550 nm is measured using a UV/Vis spectrophotometer.

TABLE 1

| | | | | | | | | | | | | | | Comparative | |
|---|---|---|---|---|---|---|---|---|---|---|---|---|---|---|---|
| | | | Examples | | | | | | | | | | | Examples | |
| | | | 1 | 2 | 3 | 4 | 5 | 6 | 7 | 8 | 9 | 10 | 11 | 1 | 2 |
| (A) PC | | | 100 | 100 | 100 | 100 | 100 | 100 | 100 | 100 | 100 | 100 | 100 | — | — |
| (B) | (B1) | B11 | 100 | 20 | 20 | 20 | 20 | 20 | 100 | 100 | 20 | 20 | 20 | 20 | 20 |
| | | B12 | — | 80 | 80 | 80 | 80 | 80 | — | — | 80 | 80 | 80 | 80 | 80 |
| | (B2) | B21 | 3 | 3 | 3 | 3 | 3 | 3 | 2 | 2 | 2 | 2 | 2 | — | — |
| | | B22 | — | — | — | — | — | — | — | — | — | — | — | 18 | 3 |

| Surface electrical | | 10⁵ | 10⁵ | 10⁸ | 10⁸ | 10⁹⁻¹⁰ | 10¹¹ | 10⁶ | 10⁸ | 10⁸ | 10⁹⁻¹⁰ | 10¹⁰⁻¹¹ | 10¹⁰ | >10¹³ |
|---|---|---|---|---|---|---|---|---|---|---|---|---|---|---|
| resistance (Ω/sq) | | | | | | | | | | | | | | |
| Transparency | | 11 | 34 | 62 | 62 | 78 | 82 | 20 | 67 | 65 | 76 | 81 | opaque | opaque |
| (%) | | | | | | | | | | | | | | |
| Thickness | (B) | 2.71 | 2.12 | 1.06 | 0.66 | 0.56 | 0.51 | 25 | 6.5 | 7 | 4.1 | 2.3 | 72 | 85 |
| (μm) | (A) + | 90 | 85 | 90 | 80 | 80 | 85 | 95 | 90 | 101 | 105 | 94 | — | — |
| | (B) | | | | | | | | | | | | | |

(weight unit: parts by weight)

As shown in Table 1, Comparative Example 1 using only carbon black exhibits a surface electrical resistance of about 10¹⁰ Ω/sq. However the carbon black is added in large amount of 18 parts by weight in order to obtain such resistance. In contrast, Example 3 using 3 parts by weight of the carbon nanotubes exhibits a surface electrical resistance of about 10¹⁰ Ω/sq at a thin thickness of about 1 μm, and also good transparency. Furthermore, Examples 10 and 11 coextruded from a resin composition using 2 parts by weight of carbon nanotubes also exhibit a surface electrical resistance of 10¹⁰ Ω/sq at a thin thickness. It can be seen that as the amount of carbon nanotubes decreases, from 3 parts by weight to 2 parts by weight, the surface layer containing 2 parts by weight of carbon nanotubes is thicker in order to obtain the same level of conductivity. On the other hand, the surface layer containing 3 parts by weight of carbon nanotubes has a sufficient conductivity at a thickness of about 1 μm. As shown in the Examples, when carbon nanotubes are mixed with a polymeric matrix, good conductivity can be obtained even with a small amount of carbon nanotubes, compared to using only carbon black, and thereby it may prevent the deterioration of mechanical properties caused by using a large amount of additives. Further, since the carbon nanotube composite film has a laminated form, it is possible to prepare film with a very small amount of carbon nanotubes and to employ various materials as a base layer.

From the above results of the Examples, the electroconductive thermoplastic resin composition of the present invention can be applicable for a transfer belt for an image forming apparatus.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A transfer belt for an image forming apparatus comprising (A) a base layer comprising a thermoplastic resin; and (B) a surface layer comprising a thermoplastic resin composite comprising carbon nanotubes dispersed therein.

2. The transfer belt of claim 1, wherein said surface layer (B) comprises about 95 to about 99.9% by weight of a thermoplastic resin and about 0.1 to about 5% by weight of carbon nanotube.

3. The transfer belt of claim 2, wherein said carbon nanotubes have a diameter of about 0.5 to about 100 nm, a length of about 0.01 to about 100 μm, and an aspect ratio of about 100 to about 1,000.

4. The transfer belt of claim 1, wherein said thermoplastic resin of said base layer and said surface layer independently comprises a polyolefin resin, polyacetal resin, acrylic resin, polymethacrylic resin, polycarbonate resin, styrenic resin, polyester resin, polyphenylene ether resin, polyarylate resin, polyamide resin, polyarylsulfone resin, polyetherimide resin, polyethersulfone resin, vinylidene fluoride resin, polysulfone resin, liquid crystal polymer resin, a copolymer thereof or a combination thereof.

5. The transfer belt of claim 4, wherein said thermoplastic resin further comprises at least one additive selected from the group consisting of reaction stabilizers, transesterification inhibitors, UV absorbing agents, thermal stabilizers, antioxidants, flame retardants, lubricants, pigments, dyes, inorganic fillers, plasticizers, impact modifiers, and combinations thereof.

6. The transfer belt of claim 1, wherein said transfer belt has a surface electrical resistance of about 1×10⁸ to about 1×10¹² Ω/sq, when a voltage of about 100 to about 250 V is applied.

7. The transfer belt of claim 1, wherein said transfer belt has a thickness of about 50 to about 150 μm.

8. The transfer belt of claim 7, wherein said surface layer (B) has a thickness of about 0.2 to about 30 μm.

9. The transfer belt of claim 7, wherein said surface layer (B) has a thickness of about 0.15 to about 3 μm, and the amount of the carbon nanotubes therein ranges from 2.5 to 5% by weight.

10. The transfer belt of claim 7, wherein said surface layer (B) has a thickness of about 2 to about 25 μm, and the amount of the carbon nanotubes therein ranges from 1 to 2.4% by weight.

11. The transfer belt of claim 1, wherein said transfer belt has a cylindrical form.

12. A method of preparing a transfer belt for an image forming apparatus comprising coextruding a thermoplastic resin to form a base layer and a thermoplastic resin composite to form a surface layer using an extruder equipped with a ring die wherein said thermoplastic resin composite includes carbon nanotubes dispersed therein.

13. The method of claim 12, wherein said thermoplastic resin composite comprises about 95 to about 99.9% by weight of a thermoplastic resin and about 0.1 to about 5% by weight of said carbon nanotubes.

14. A transparent film comprising (A) a base layer comprising a thermoplastic resin; and (B) a surface layer comprising a thermoplastic resin composite comprising carbon nanotubes dispersed therein, wherein said film has a cylindrical form.

15. The transparent film of claim 14, wherein said surface layer (B) comprises about 95 to about 99.9% by weight of the thermoplastic resin and about 0.1 to about 5% by weight of the carbon nanotubes.

16. The transparent film of claim 14, wherein said carbon nanotubes have a diameter of about 0.5 to about 100 nm, a length of about 0.01 to about 100 μm, and an aspect ratio of about 100 to about 1,000.

17. The transparent film of claim 14, wherein said thermoplastic resin of said base layer and said surface layer independently comprises a polyolefin resin, polyacetal resin, acrylic resin, polymethacrylic resin, polycarbonate resin, styrenic resin, polyester resin, polyphenylene ether resin, polyarylate resin, polyamide resin, polyarylsulfone resin, polyetherimide resin, polyethersulfone resin, vinylidene fluoride resin, polysulfone resin, liquid crystal polymer resin, a copolymer thereof or a combination thereof.

18. The transparent film of claim 14, wherein said thermoplastic resin further comprises at least one additive selected from the group consisting of reaction stabilizers, transesterification inhibitors, UV absorbing agents, thermal stabilizers, antioxidants, flame retardants, lubricants, pigments, dyes, inorganic fillers, plasticizers, impact modifiers, and combinations thereof.
